(19) United States
(12) Patent Application Publication
(10) Pub. No.: US 2016/0192319 A1
(43) Pub. Date: Jun. 30, 2016

(54) PI reporting method and system, UE, network device and computer storage medium

(71) Applicant: ZTE CORPORATION, Guangdong (CN)

(72) Inventors: Yin Gao, Shenzhen (CN); Ying Huang, Shenzhen (CN); Feng Xie, Shenzhen (CN)

(21) Appl. No.: 14/909,245

(22) PCT Filed: Apr. 15, 2014
(86) PCT No.: PCT/CN2014/075399

§ 371 Date: Feb. 1, 2016

(30) Foreign Application Priority Data
Aug. 7, 2013 (CN) 201310342139.X

(51) Int. Cl. H04W 64/00; H04W 48/16

(52) U.S. Cl. CPC H04W 64/003; H04W 48/16

(57) ABSTRACT

Disclosed are a method and a system for reporting a Proximity Indication (PI), User Equipment (UE) and network equipment. The method includes that: UE receives a PI information request from a network side; and the UE reports PI information according to the PI information request. Based on this solution, the embodiments of the present disclosure may implement pertinent reporting of the PI information for multiple cell types under control of the network side in a complex small cell network environment, reduce unnecessary information reporting and resource waste on an air interface and enable the network side to effectively implement small cell discovery, handover judgment optimization processing and the like by virtue of the PI information reported by the UE, thereby achieving higher accuracy and effectiveness of PI information reporting and facilitating improvement in network performance.

### TECHNICAL FIELD

The present disclosure relates to application of a small cell, and in particular to a method and a system for reporting a Proximity Indication (PI), User Equipment (UE), network equipment and a computer storage medium.

### BACKGROUND

With development of wireless multimedia services, people have more or more requirements on high data speeds and good user experiences, so that higher requirements on system capacity and coverage of a conventional cellular network are set forth. In a conventional Long Term Evolution (LTE) cellular network, a Macrocell as a unique access side network element provides access service for UE. In order to meet a requirement of a user on a higher data speed and improve spectral efficiency of the cellular network, the 3rd Generation Partnership Project (3GPP) introduces a small cell as a supplement of the Macrocell to provide access service for UE. A small cell is derived from a Femtocell initially designed for a home scenario. “Small” of the small cell is relative to a conventional Macrocell, and the small cell is characterized in miniaturization, low transmitted power, high controllability, intelligence and flexibility in networking. In terms of transmitted power, typical transmitted power is 100 mW to 5 W. In terms of weight, the weight is usually 2 to 10 kg. In terms of networking manner, back transmission of multiple technologies including a Digital Subscriber Loop (DSL)/optical fibre/Wireless Local Area Network (WLAN) and a cellular technology is supported. Moreover, the small cell also has Self-Organized Network (SON) functions of automatic neighbouring cell discovery, self-configuration and the like.

A small cell has four product forms. The first is called a Femtocell, mainly configured for home and enterprise environments. The second is called a Picocell, applied to an indoor public place such as an airport, a railway station and a shopping centre. The third is called a Microcell, configured for an urban area or village where a Macrocell is not allowed to be deployed due to limits of an occupied area. The last is called a Metrocell, mainly configured for a hotspot of an urban area or a village for capacity bottleneck reduction. FIG. 1 is a diagram of a small cell network environment. As shown in FIG. 1, the small cell network environment is very complex, and the number of small cell equipment is obviously increased by orders of magnitude compared with that of a conventional Macrocell network.

Since Sprint deployed the first Femtocell in the world in September, 2007, small cells have been successfully deployed in 41 networks in 23 countries, and there have been deployed more than 3.8 millions of small cells throughout the world, mainly (80%) in form of Femtocell. In terms of regional distribution, the small cells are mainly distributed in United States (Sprint deploys more than 0.9 million/AT&T deploys about 0.5 million), Europe, Japan and Korea (Softbank of Japan deploys 0.12 million).

In a hotspot deployment scenario, for achieving a higher data speed and spectral efficiency, it is necessary to densely deploy a large number of small cells in an area, Macrocells and the small cells may adopt different frequency points, and the small cells may also adopt different frequency points. Particularly in an indoor deployment scenario, such as an office and a shopping mall which are usually multi-storey buildings, small cells may be deployed in different storeys, and working frequency and power of the small cells in different storeys may be different.

In an existing Closed Subscriber Group (CSG) Femtocell environment, for implementing timely handover of UE from a Macrocell to a CSG Femtocell, a method for reporting a PI is adopted. In an existing method, UE leaves or enters coverage of one or more CSG member cells to trigger PI reporting. How the UE triggers PI reporting is internally implemented, and is not specified in detail in an existing standard. For example, the UE may make a judgment about entering or leaving coverage of one or more CSG cells and trigger PI reporting by virtue of own position information and related information which has been stored before, such as frequency points, Evolved Universal Terrestrial Radio Access Network Cell Global Identities (ECGIs), Physical Cell ID (PCIs), position information and CSG IDs, of the CSG cells that the UE entered before. In addition, a network side contains simple PI reporting control indication information configured to indicate the UE to start or stop PI reporting of an LTE system or a UTRAN system in a Radio Resource Control (RRC) connection reconfiguration message. After the UE reports the PI, the network side transmits a measurement control command according to the frequency point and RAT information in the PI, and the UE may report a measurement result for triggering handover judgment.

At present, the concept of CSG is not adopted for a small cell, and then UE may trigger judgment by virtue of historical information, which is stored in own footprint, of a small cell that the UE entered before. However, based on such a triggering manner, PI reporting of UE according to own judgment information may cause reporting of a large amount of PI information because there are numerous small cells (compared with CSG member cells). Although the network side may adopt a simple control manner at present, it is necessary to consider a more reasonable PI reporting control and acquisition method in a complex small cell network environment. For example, in a Small Cell Enhancement (SCE) scenario where small cells are densely deployed, it is necessary to consider enabling a terminal to accurately report required small cell information for different types and geographical positions to avoid impact on signalling resources on an air interface, simultaneously improving accuracy of PI information reporting and implementing effective utilization of the reported information.

### SUMMARY

In view of this, the embodiments of the present disclosure are mainly intended to provide a method and a system for reporting a PI, UE and network equipment, which may increase accuracy and effectiveness of PI information reporting in a small cell network environment and may save signalling resources on the air interface.

To this end, the technical solutions of the embodiments of the present disclosure are implemented as follows.

A method for reporting a PI is provided, which includes:

UE receives a PI information request from a network side; and

the UE reports corresponding PI information according to the PI information request.

Preferably, the PI information request may contain at least one or more of: a PI information reporting indicator, RAT/frequency point information specified to be reported, a cell type and specified geographical position information.

Preferably, the step that the UE receives the PI information request from the network side may include that: the UE receives the PI information request contained in a private or public message from the network side.

Preferably, before the step that the UE receives the PI information request from the network side, the method may further include that:

the UE sends PI indication information to the network side to indicate that the UE currently has PI information required to be reported; and

the step that the UE receives the PI information request from the network side may be implemented as follows: the UE receives the PI information request sent according to the PI indication information by the network side, the PI information request containing at least one or more of: the specified RAT/frequency point information, the cell type and the specified geographical position information.

Preferably, the PI indication information may be contained in a measurement result reporting message or an independent message, and

the PI information request may be contained in a measurement control command message or an independent message.

Preferably, the network side may include at least any one of: a Macrocell, a Femtocell, a Picocell, a Microcell and a Metrocell.

Preferably, the PI information reported by the UE may include one or more of: RAT/frequency point information of a small cell, the cell type, an ECGI of the small cell, Tracking Area Identity (TAI) information of the reported cell and broadcast Public Land Mobile Network (PLMN) list information of the reported cell.

UE is provided, which includes a receiving module and a reporting module, wherein

the receiving module is configured to receive a PI information request from a network side; and

the reporting module is configured to report corresponding PI information according to the PI information request received by the receiving module.

Preferably, the PI information request received by the receiving module may contain at least one or more of: a PI information reporting indicator, RAT/frequency point information specified to be reported, a cell type and specified geographical position information.

Preferably, the receiving module may specifically be configured to receive the PI information request contained in a private or public message from the network side.

Preferably, the UE may further include a sending module, wherein

the sending module may be configured to send PI indication information to the network side to indicate that the UE currently has PI information required to be reported; and

the receiving module may specifically be configured to receive the PI information request sent according to the PI indication information by the network side, the PI information request containing at least one or more of: the specified RAT/frequency point information, the cell type and the specified geographical position information.

Preferably, the sending module may specifically be configured to contain the PI indication information in a measurement result reporting message or an independent message, and

the receiving module may specifically be configured to contain the PI information request in a measurement control command message or an independent message.

Preferably, the PI information reported by the reporting module may include one or more of: RAT/frequency point information of a small cell, the cell type, an ECGI of the small cell, TAI information of the reported cell and broadcast PLMN list information of the reported cell.

Network equipment is provided, which includes a sending module and a receiving module, wherein

the sending module is configured to send a PI information request to UE; and

the receiving module is configured to receive corresponding PI information reported according to the PI information request by the UE.

Preferably, the PI information request sent by the sending module may contain at least one or more of: a PI information reporting indicator, RAT/frequency point information specified to be reported, a cell type and specified geographical position information.

Preferably, the sending module may specifically be configured to contain the PI information request in a private or public message.

Preferably, the receiving module may further be configured to receive PI indication information from the UE, the PI indication information indicating that the UE currently has PI information required to be reported; and

the sending module may specifically be configured to send the PI information request according to the PI indication information, the PI information request containing at least one or more of: the specified RAT/frequency point information, the cell type and the specified geographical position information.

Preferably, the receiving module may specifically be configured to receive the PI indication information contained in a measurement result reporting message or an independent message; and

the sending module may specifically be configured to contain the PI information request in a measurement control command message or an independent message.

Preferably, the network equipment may be a Macrocell, a Femtocell, a Picocell, a Microcell or a Metrocell.

Preferably, the PI information received by the receiving module may include one or more of: RAT/frequency point information of a small cell, the cell type, an ECGI of the small cell, TAI information of the reported cell and broadcast PLMN list information of the reported cell.

A system for reporting a PI is provided, which includes UE and network equipment, wherein

the UE may be the abovementioned UE; and

the network equipment may be the abovementioned network equipment.

A computer storage medium is provided having computer-executable instructions stored therein, the computer-executable instructions being configured to execute the abovementioned method.

According to the method and system for reporting the PI, the UE, the network equipment and the computer storage medium of the embodiments of the present disclosure, the UE receives the PI information request from the network side; and reports the corresponding PI information according to the PI information request. Based on the abovementioned solutions, the embodiments of the present disclosure may implement pertinent reporting of the PI information for multiple cell types under control of the network side in a complex small cell network environment, reduce unnecessary information reporting and resource waste on an air interface and enable the network side to effectively implement small cell discovery, handover judgment optimization processing and the like by virtue of the PI information reported by the UE, thereby achieving higher accuracy and effectiveness of PI information reporting and facilitating improvement in network performance.

### BRIEF DESCRIPTION OF THE DRAWINGS

FIG. 1 is diagram illustrating a small cell network environment;

FIG. 2 is a flowchart showing a method for reporting a PI according to an embodiment of the present disclosure;

FIG. 3 is a flowchart showing another method for reporting a PI according to an embodiment of the present disclosure;

FIG. 4 is a diagram illustrating a structure of UE according to an embodiment of the present disclosure;

FIG. 5 is a diagram illustrating another structure of UE according to an embodiment of the present disclosure;

FIG. 6 is a structure diagram illustrating network equipment according to an embodiment of the present disclosure;

FIG. 7 is a flowchart showing PI reporting according to embodiment 1 of the present disclosure;

FIG. 8 is a flowchart showing PI reporting according to embodiment 2 of the present disclosure;

FIG. 9 is a flowchart showing PI reporting according to embodiment 3 of the present disclosure; and

FIG. 10 is a flowchart showing PI reporting according to embodiment 4 of the present disclosure.

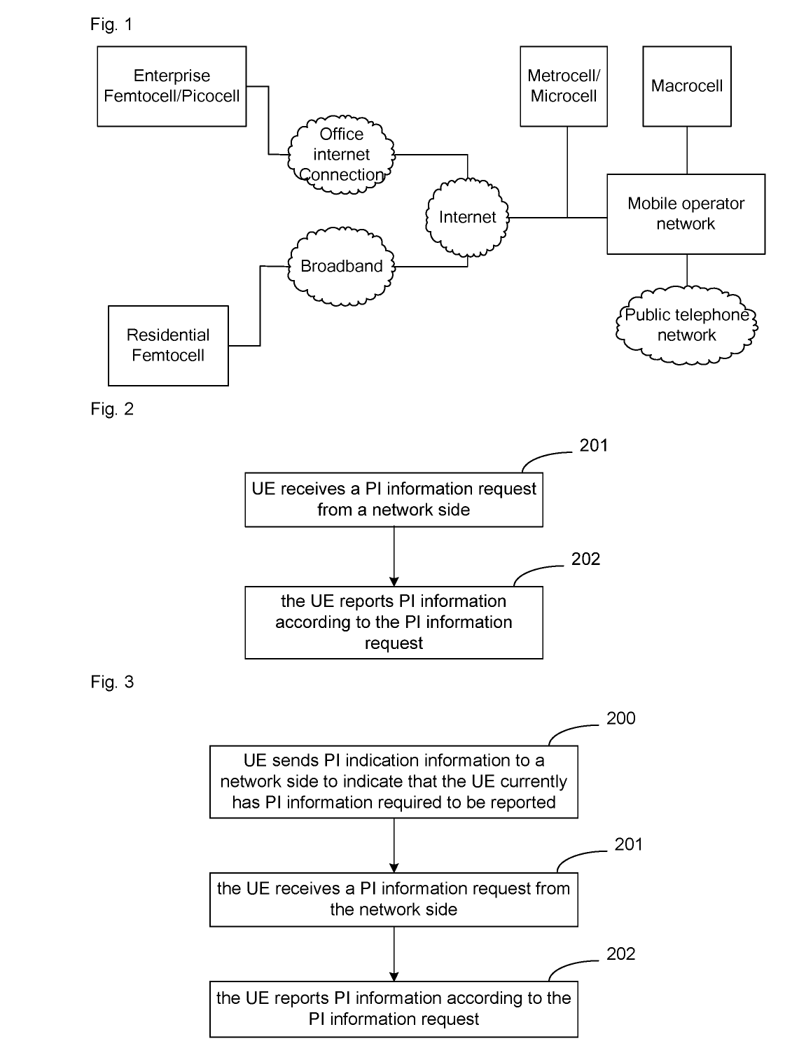

### DETAILED DESCRIPTION

In each embodiment of the present disclosure, UE receives a PI information request from a network side; and the UE reports PI information according to the PI information request.

The embodiment of the present disclosure provides a method for reporting a PI. As shown in FIG. 2, the method includes:

Step 201: UE receives a PI information request from a network side; and

Step 202: the UE reports PI information according to the PI information request.

Optionally, the PI information request contains at least one or more of: a PI information reporting indicator, RAT/frequency point information specified to be reported, a cell type and specified geographical position information (such as latitude and longitude information).

Optionally, the step that the UE receives the PI information request from the network side is implemented as follows: the UE receives the PI information request contained in a private or public message from the network side. In the embodiment, the network side sends the PI information request to the UE through the private or public message to indicate that the UE needs to perform PI reporting of a small cell, and then the UE may trigger autonomous PI reporting.

Optionally, as shown in FIG. 3, before the step that the UE receives the PI information request from the network side, the method further includes:

Step 200: the UE sends PI indication information to the network side to indicate that the UE currently has PI information required to be reported, wherein the PI indication information may be a TRUE/FALSE indicator; and

accordingly, the step that the UE receives the PI information request from the network side is implemented as follows: the UE receives the PI information request sent according to the PI indication information by the network side, the PI information request containing at least one or more of: the specified RAT/frequency point information, the cell type and the specified geographical position information. In the embodiment, the network side sends the PI information request to the UE according to the PI indication information to instruct the UE to report specified PI information.

Optionally, the PI indication information is contained in a measurement result reporting message or an independent message, and

the PI information request is contained in a measurement control command message or an independent message.

In the embodiment of the present disclosure, the network side refers to an access network element device in a current small cell network environment, and the network side optionally includes at least any one of: a Macrocell, a Femtocell, a Picocell, a Microcell and a Metrocell.

Optionally, the PI information reported by the UE includes one or more of: RAT/frequency point information of a small cell, the cell type, an ECGI of the small cell, Tracking Area Identity (TAI) information of the reported cell and broadcast Public Land Mobile Network (PLMN) list information of the reported cell.

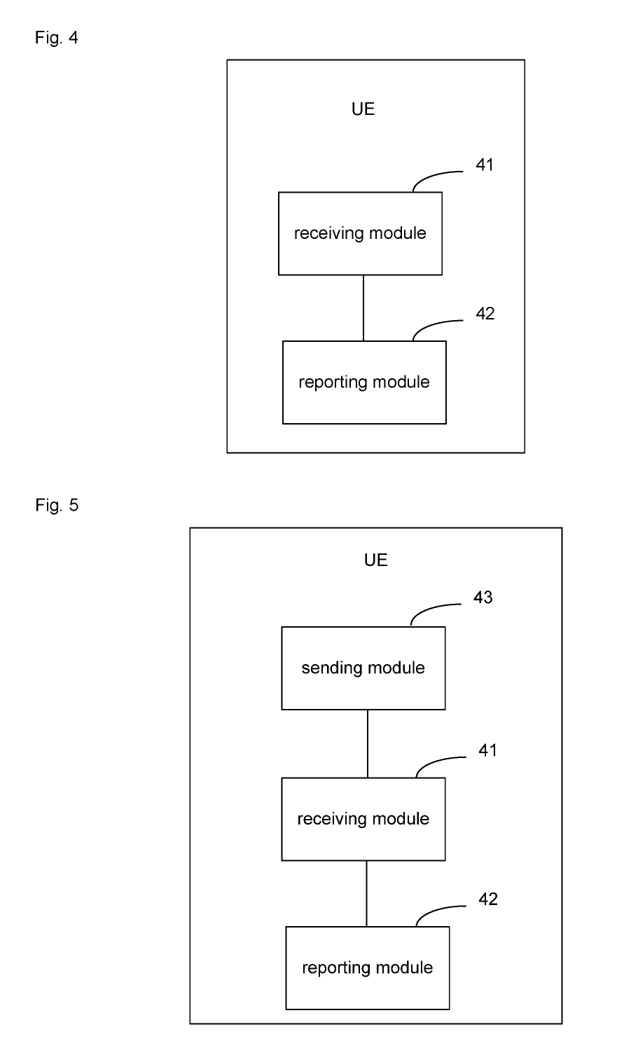

The embodiment of the present disclosure further provides UE. As shown in FIG. 4, the UE includes a receiving module 41 and a reporting module 42.

The receiving module 41 is configured to receive a PI information request from a network side.

The reporting module 42 is configured to report PI information according to the PI information request received by the receiving module 41.

Optionally, the PI information request received by the receiving module 41 contains at least one or more of: a PI information reporting indicator, RAT/frequency point information specified to be reported, a cell type and specified geographical position information.

Optionally, the receiving module 41 is specifically configured to receive the PI information request contained in a private or public message from the network side.

Optionally, as shown in FIG. 5, the UE further includes a sending module 43.

The sending module 43 is configured to send PI indication information to the network side to indicate that the UE currently has PI information required to be reported.

The receiving module 41 is specifically configured to receive the PI information request sent according to the PI indication information by the network side, the PI information request containing at least one or more of: the specified RAT/frequency point information, the cell type and the specified geographical position information.

Optionally, the sending module 43 is specifically configured to contain the PI indication information in a measurement result reporting message or an independent message, and

the receiving module 41 is specifically configured to contain the PI information request in a measurement control command message or an independent message.

Optionally, the PI information reported by the reporting module 42 includes one or more of: RAT/frequency point information of a small cell, the cell type, an ECGI of the small cell, TAI information of the reported cell and broadcast PLMN list information of the reported cell.

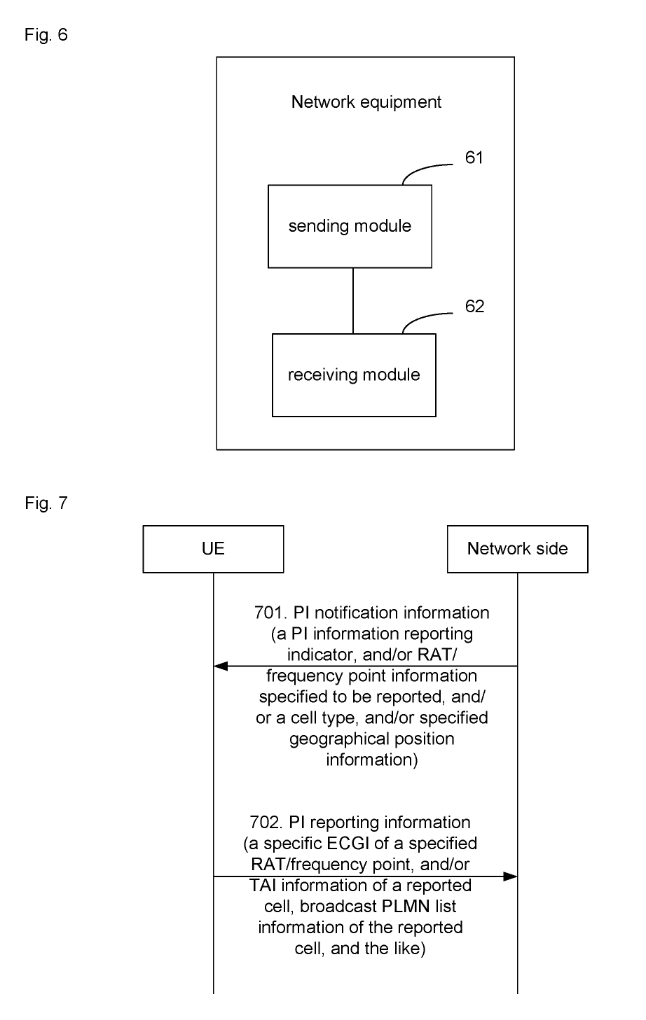

The embodiment of the present disclosure further provides network equipment. As shown in FIG. 6, the network equipment includes a sending module 61 and a receiving module 62.

The sending module 61 is configured to send a PI information request to UE.

The receiving module 62 is configured to receive PI information reported according to the PI information request by the UE.

Optionally, the PI information request sent by the sending module 61 contains at least one or more of: a PI information reporting indicator, RAT/frequency point information specified to be reported, a cell type and specified geographical position information.

Optionally, the sending module 61 is specifically configured to contain the PI information request in a private or public message.

Optionally, the receiving module 62 is further configured to receive PI indication information from the UE, the PI indication information indicating that the UE currently has PI information required to be reported; and

the sending module 61 is specifically configured to send the PI information request according to the PI indication information, the PI information request containing at least one or more of: the specified RAT/frequency point information, the cell type and the specified geographical position information.

Optionally, the receiving module 62 is specifically configured to receive the PI indication information contained in a measurement result reporting message or an independent message; and

the sending module 61 is specifically configured to contain the PI information request in a measurement control command message or an independent message.

Optionally, the network equipment is a Macrocell, a Femtocell, a Picocell, a Microcell or a Metrocell.

Optionally, the PI information received by the receiving module 62 includes one or more of: RAT/frequency point information of a small cell, the cell type, an ECGI of the small cell, TAI information of the reported cell and broadcast PLMN list information of the reported cell.

The embodiment of the present disclosure further provides a system for reporting a PI, which includes UE and network equipment.

The UE is the abovementioned UE; and

the network equipment is the abovementioned network equipment.

The embodiment of the present disclosure provides a computer storage medium having computer-executable instructions stored therein, the computer-executable instructions being configured to execute the abovementioned method.

The technical solutions of the present disclosure are further described below with reference to specific embodiments in detail.

### Embodiment 1

The UE which resides in a small cell may keep related information of the small cell in footprint, including, but not limited to, one or more of: an ECGI of the small cell, TAI information corresponding to the small cell, position information of the UE at the time of recording, RAT and frequency point information of the small cell, cell type information and signal quality of a macro cell at the time of recording, for example.

Here, the cell type information refers to information configured to distinguish different types of small cells, and there are many types of small cells at present, such as a Macrocell, a Femtocell, a Picocell, a Microcell and a Metrocell.

FIG. 7 is a flowchart showing PI reporting according to embodiment 1 of the present disclosure, and as shown in FIG. 7, the flow includes the following steps.

Step 701: a network side sends PI notification information to UE through a private or public message to indicate that the UE needs to perform small cell PI reporting, and then the UE may trigger autonomous PI reporting.

The PI notification information may include at least one of: a PI information reporting indicator, RAT/frequency point information specified to be reported, a cell type and specified geographical position information such as latitude and longitude information.

Step 702: the UE performs local processing according to the content in the PI notification information, and reports PI information. For example, the UE may compare the RAT/frequency point information, and/or cell type and/or specified geographical position information required to be reported with the historical information of the small cell which is locally stored in footprint, and retrieve a small cell which meets the reporting requirement for reporting. The PI information includes, but not limited to, at least one of: an ECGI of a specific small cell of a specified RAT/frequency point, TAI information of the reported cell, broadcast PLMN list information of the reported cell, and the like.

### Embodiment 2

The UE which resides in a small cell may keep related information of the small cell in footprint, including, but not limited to, one or more of: an ECGI of the small cell, TAI information corresponding to the small cell, position information of the UE at the time of recording, RAT and frequency point information of the small cell, cell type information and signal quality of a macro cell at the time of recording, for example.

Here, the cell type information refers to information configured to distinguish different types of small cells, and there are many types of small cells at present, such as a Macrocell, a Femtocell, a Picocell, a Microcell and a Metrocell.

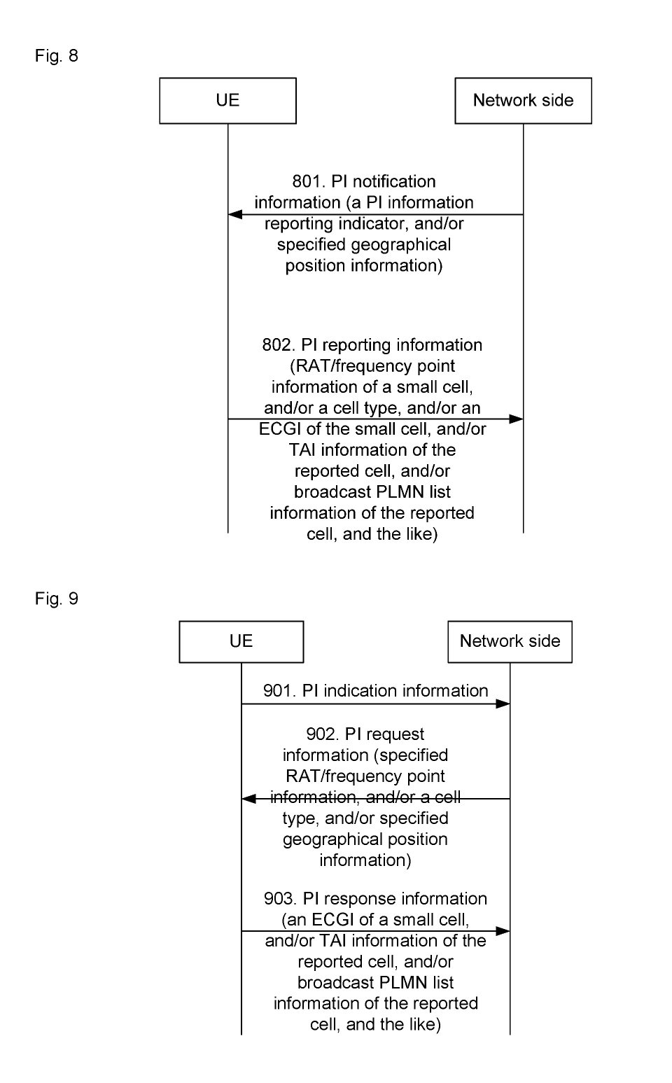

FIG. 8 is a flowchart showing PI reporting according to embodiment 2 of the present disclosure, and as shown in FIG. 8, the flow includes the following steps.

Step 801: a network side sends PI notification information to UE through a private or public message to indicate that the UE needs to perform small cell PI reporting, and then the UE may trigger autonomous PI reporting.

The PI notification information may include at least one of: a PI information reporting indicator and specified geographical position information such as latitude and longitude information.

Step 802: the UE performs local processing according to the content in the PI notification information, and reports PI information. For example, the UE may compare the specified geographical position information required to be reported with the historical information of the small cell which is locally stored in footprint, and retrieve a small cell which meets the reporting requirement for reporting. The PI information includes, but not limited to, at least one of: RAT/frequency point information of the small cell, a cell type, an ECGI of the small cell, TAI information of the reported cell, broadcast PLMN list information of the reported cell, and the like.

### Embodiment 3

The UE which resides in a small cell may keep related information of the small cell in footprint, including, but not limited to, one or more of: an ECGI of the small cell, TAI information corresponding to the small cell, position information of the UE at time of recording, RAT and frequency point information of the small cell, cell type information and signal quality of a macro cell at the time of recording, for example.

Here, the cell type information refers to information configured to distinguish different types of small cells, and there are many types of small cells at present, such as a Macrocell, a Femtocell, a Picocell, a Microcell and a Metrocell.

FIG. 9 is a flowchart showing PI reporting according to embodiment 3 of the present disclosure, and as shown in FIG. 9, the flow includes the following steps.

Step 901: the UE reports PI indication information to a network side.

The PI indication information indicates that the UE currently has PI information required to be reported, and may be a TRUE/FALSE indicator.

Herein, the PI indication information may be contained in a measurement result report, and may also be an independent message.

Step 902: the network side sends PI request information to the UE according to the PI indication information to instruct the UE to report specified PI information.

The PI request information includes PI information reporting instruction information, and includes at least one of: specified RAT/frequency point information, a cell type and specified geographical position information such as latitude and longitude information.

Herein, the PI request information may be contained in a measurement control command message, and may also be an independent message.

Step 903: the UE reports specified PI response information to the network side.

The UE performs local processing according to the content in the PI request message, and reports the PI response information. For example, the UE may compare at least one of the RAT/frequency point information, and/or the cell type and/or the specified geographical position information required to be reported with the historical information of the small cell which is locally stored in footprint, and retrieve a small cell which meets the reporting requirement for reporting. The PI response information includes, but not limited to, information of one or more specific small cells of a specified RAT/frequency point, including, but not limited to, at least one of: an ECGI of the small cell, TAI information of the reported cell, broadcast PLMN list information of the reported cell, and the like.

Herein, the PI response information may be contained in a measurement result reporting message, and may also be an independent message.

### Embodiment 4

The UE which resides in a small cell may keep related information of the small cell in footprint, including, but not limited to, one or more of: an ECGI of the small cell, TAI information corresponding to the small cell, position information of the UE at time of recording, RAT and frequency point information of the small cell, cell type information and signal quality of a macro cell at the time of recording, for example.

Here, the cell type information refers to information configured to distinguish different types of small cells, and there are many types of small cells at present, such as a Macrocell, a Femtocell, a Picocell, a Microcell and a Metrocell.

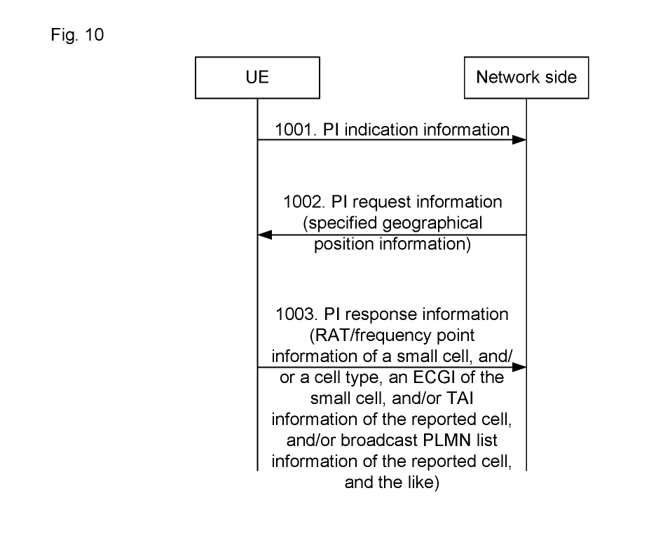

FIG. 10 is a flowchart showing PI reporting according to embodiment 4 of the present disclosure, and as shown in FIG. 10, the flow includes the following steps.

Step 1001: the UE reports PI indication information to a network side.

The PI indication information indicates that the UE currently has PI information required to be reported, and may be a TRUE/FALSE indicator.

Herein, the PI indication information may be contained in a measurement result report, and may also be an independent message.

Step 1002: the network side sends PI request information to the UE according to the PI indication information to instruct the UE to report specified PI information.

The PI request information includes PI information reporting instruction information, and includes specified geographical position information such as latitude and longitude information.

Herein, the PI request information may be contained in a measurement control command message, and may also be an independent message.

Step 1003: the UE reports specified PI response information to the network side.

The UE performs local processing according to the content in the PI request message, and reports the PI response information. For example, the UE may compare the specified geographical position information with the historical information of the small cell which is locally stored in footprint, and retrieve a small cell which meets the reporting requirement for reporting. The PI response information includes, but not limited to, at least one of: RAT/frequency point information of the small cell, a cell type, an ECGI of the small cell, TAI information of the reported cell, broadcast PLMN list information of the reported cell, and the like.

Herein, the PI response information may be contained in a measurement result reporting message, and may also be an independent message.

The solutions of the embodiments of the present disclosure may implement pertinent reporting of the PI information for multiple cell types under control of the network side in a complex small cell network environment, reduce unnecessary information reporting and resource waste on an air interface and enable the network side to effectively implement small cell discovery, handover judgment optimization processing and the like by virtue of the PI information reported by the UE, thereby facilitating improvement in network performance.

Each unit as described above may be implemented by a Central Processing Unit (CPU), Digital Signal Processor (DSP) or Field-Programmable Gate Array (FPGA) in electronic equipment.

Those skilled in the art should know that the embodiments of the present disclosure may be provided as a method, a system or a computer program product. Therefore, the present disclosure may adopt hardware, software or combination thereof. Moreover, the present disclosure may adopt computer program product implemented on one or more computer-available storage media (including, but not limited to, a disk memory and an optical memory) including computer-available program codes.

The present disclosure is described with reference to flowcharts and/or block diagrams of the method, equipment (system) and computer program product according to the embodiments of the present disclosure. It should be understood that each flow and/or block in the flowcharts and/or the block diagrams and combinations of the flows and/or blocks in the flowcharts and/or the block diagrams may be implemented by computer program instructions. These computer program instructions may be provided for a general computer, a dedicated computer, an embedded processor or a processor of other programmable data processing equipment to generate a machine, so that a device for realizing a function specified in one flow or more flows in the flowcharts and/or one block or more blocks in the block diagrams is generated by the instructions executed through the computer or the processor of the other programmable data processing equipment.

These computer program instructions may also be stored in a computer-readable memory capable of instructing the computer or the other programmable data processing equipment to work in a specific manner, so that a product including an instruction device may be generated by the instructions stored in the computer-readable memory, the instruction device realizing the functions specified in one flow or many flows in the flowcharts and/or one block or many blocks in the block diagrams.

These computer program instructions may further be loaded onto the computer or the other programmable data processing equipment, so that a series of operating steps are executed on the computer or the other programmable data processing equipment to generate processing implemented by the computer, and steps for realizing the function specified in one flow or many flows in the flowcharts and/or one block or many blocks in the block diagrams are provided by the instructions executed on the computer or the other programmable data processing equipment.

The above is only the preferred embodiments of the present disclosure and not intended to limit the scope of protection of the present disclosure.

### INDUSTRIAL APPLICABILITY

According to the method and system for reporting the PI, the UE, the network equipment and the computer storage medium of the embodiments of the present disclosure, the UE receives the PI information request from the network side; and the UE reports the corresponding PI information according to the PI information request. Based on the abovementioned solutions, the embodiments of the present disclosure may implement pertinent reporting of the PI information for multiple cell types under control of the network side in a complex small cell network environment, reduce unnecessary information reporting and resource waste on an air interface and enable the network side to effectively implement small cell discovery, handover judgment optimization processing and the like by virtue of the PI information reported by the UE, thereby achieving higher accuracy and effectiveness of PI information reporting and facilitating improvement in network performance.

1. A method for reporting a Proximity Indication (PI), comprising:
receiving, by User Equipment (UE), a PI information request from a network side; and
reporting, by the UE, PI information according to the PI information request.

2. The method according to claim 1, wherein the PI information request comprises at least one or more of: a PI information reporting indicator, RAT/frequency point information specified to be reported, a cell type and specified geographical position information.

3. The method according to claim 1, wherein the step of receiving, by the UE, the PI information request from the network side is implemented by: receiving, by the UE, the PI information request contained in a private or public message from the network side.

4. The method according to claim 1, further comprising: before receiving, by the UE, the PI information request from the network side,
sending, by the UE, PI indication information to the network side to indicate that the UE currently has PI information required to be reported, wherein
the step of receiving, by the UE, the PI information request from the network side is implemented by: receiving, by the UE, the PI information request sent according to the PI indication information by the network side, the PI information request containing at least one or more of: specified RAT/frequency point information, a cell type and specified geographical position information.

5. The method according to claim 4, wherein
the PI indication information is contained in a measurement result reporting message or an independent message, and
the PI information request is contained in a measurement control command message or an independent message.

6. The method according to claim 1, wherein the network side comprises at least any one of: a Macrocell, a Femtocell, a Picocell, a Microcell and a Metrocell.

7. The method according to claim 1, wherein the PI information reported by the UE comprises one or more of: RAT/frequency point information of a small cell, a cell type, an Evolved Universal Terrestrial Radio Access Network Cell Global Identity (ECGI) of a small cell, Tracking Area Identity (TAI) information of a reported cell and broadcast Public Land Mobile Network (PLMN) list information of a reported cell.

8. User Equipment (UE), comprising a receiving module and a reporting module, wherein
the receiving module is configured to receive a Proximity Indication (PI) information request from a network side; and
the reporting module is configured to report PI information according to the PI information request received by the receiving module.

9. The UE according to claim 8, wherein the PI information request received by the receiving module comprises at least one or more of: a PI information reporting indicator, RAT/frequency point information specified to be reported, a cell type and specified geographical position information.

10. The UE according to claim 8, wherein
the receiving module is further configured to receive the PI information request contained in a private or public message from the network side.

11. The UE according to claim 8, further comprising a sending module, wherein
the sending module is configured to send PI indication information to the network side to indicate that the UE currently has PI information required to be reported; and
the receiving module is further configured to receive the PI information request sent according to the PI indication information by the network side, the PI information request containing at least one or more of: specified RAT/frequency point information, a cell type and specified geographical position information.

12. The UE according to claim 11, wherein
the sending module is further configured to contain the PI indication information in a measurement result reporting message or an independent message, and
the receiving module is further configured to contain the PI information request in a measurement control command message or an independent message.

13. The UE according to claim 8, wherein the PI information reported by the reporting module comprises one or more of: RAT/frequency point information of a small cell, a cell type, an Evolved Universal Terrestrial Radio Access Network Cell Global Identity (ECGI) of a small cell, Tracking Area Identity (TAI) information of a reported cell and broadcast Public Land Mobile Network (PLMN) list information of a reported cell.

14. Network equipment, comprising a sending module and a receiving module, wherein
the sending module is configured to send a Proximity Indication (PI) information request to User Equipment (UE); and
the receiving module is configured to receive PI information reported according to the PI information request by the UE.

15. The network equipment according to claim 14, wherein
the PI information request sent by the sending module contains at least one or more of: a PI information reporting indicator, RAT/frequency point information specified to be reported, a cell type and specified geographical position information.

16. The network equipment according to claim 14, wherein
the sending module is further configured to contain the PI information request in a private or public message.

17. The network equipment according to claim 14, wherein
the receiving module is further configured to receive PI indication information from the UE, the PI indication information indicating that the UE currently has PI information required to be reported; and
the sending module is further configured to send the PI information request according to the PI indication information, the PI information request containing at least one or more of: specified RAT/frequency point information, a cell type and specified geographical position information.

18. The network equipment according to claim 17, wherein
the receiving module is further configured to receive the PI indication information contained in a measurement result reporting message or an independent message; and
the sending module is further configured to contain the PI information request in a measurement control command message or an independent message.

19. (canceled)

20. The network equipment according to claim 14, wherein the PI information received by the receiving module comprises one or more of: RAT/frequency point information of a small cell, a cell type, an Evolved Universal Terrestrial Radio Access Network Cell Global Identity (ECGI) of a small cell, Tracking Area Identity (TAI) information of a reported cell and broadcast Public Land Mobile Network (PLMN) list information of a reported cell.

21. (canceled)

22. A computer storage medium having computer-executable instructions stored therein, the computer-executable instructions being configured to execute a method, wherein the method comprises:
receiving, by User Equipment (UE), a PI information request from a network side; and
reporting, by the UE, PI information according to the PI information.
